(19) United States
(12) Patent Application Publication
(10) Pub. No.: US 2024/0298577 A1
(43) Pub. Date: Sep. 12, 2024

(54) Docking Unit For A Lawn Mower Blade Sharpening And Task Robot

(71) Applicant: Brian F. Smith, Monkton, MD (US)

(72) Inventor: Brian F. Smith, Monkton, MD (US)

(21) Appl. No.: 18/595,638

(22) Filed: Mar. 5, 2024

Related U.S. Application Data
(60) Provisional application No. 63/450,698, filed on Mar. 8, 2023.

(51) Int. Cl. A01D 75/08; A01D 101/00; B60D 1/00; B60D 1/01; G05D 1/661; G05D 105/15

(52) U.S. Cl. CPC A01D 75/08; B60D 1/01; G05D 1/661; A01D 2101/00; B60D 2001/008; G05D 2105/15

(57) ABSTRACT

Provided are systems and methods for docking a robot relative to a lawn mower. The system may include a drive system configured to move the robot, a sensor, a docking arm, and/or at least one processor operatively connected to the drive system, the sensor, and/or the docking arm. The at least one processor may be configured to receive a signal from the sensor comprising a first location of the robot. The processor may be configured to control the drive system to drive from the first location to a second location based on receiving the signal. The at least one processor may be configured to control the docking arm to dock the robot at the second location, where the robot is configured to perform a task. The at least one processor may be configured to control the docking arm to un-dock the robot upon completion of the task.

### CROSS REFERENCE TO RELATED APPLICATION(S)

The present application claims the benefit of U.S. Provisional Patent Application No. 63/450,698 filed on Mar. 8, 2023, the disclosure of which is hereby incorporated by reference in its entirety.

### BACKGROUND

### 1. Technical Field

The present disclosure relates generally to systems and methods for docking a robot, and in non-limiting embodiments, to systems and methods for docking a blade sharpening and task robot relative to a lawn mower.

### 2. Technical Considerations

Lawn mowers include blades that are used to cut grass. The blades of a lawn mower must be kept sharp to run efficiently and to prevent disease of grass. Typical methods for sharpening blades of a lawn mower require a user to detach the blades from underneath a bottom side of the lawn mower, sharpen the blades, and re-attach the blades. Such methods may be performed manually or via a robot.

Accuracy for understanding and/or addressing issues associated with the blades of a lawn mower and/or other components of a lawn mower (e.g., wheels, discharge chutes, mower decks, etc.) is paramount to the care of a lawn mower. In order to service and/or view the blades of a lawn mower and/or other components of a lawn mower, an individual must jack-up the lawn mower and/or lawn mower deck, and/or remove the lawn mower deck, and/or manually guide a viewing device under the lawn mower and/or lawn mower deck. This proves to be antiquated, time consuming, and/or difficult for most individuals.

In order to sharpen a lawn mower blade and/or service it in anyway, an individual most likely will remove the lawn mower blade from the lawn mower. Once removed, at this point, the individual will either hold the blade by hand, place it in a vise of some sort, or stabilize the blade in some manner. Once stabilized, the individual will sharpen or conduct some sort of maintenance on the blade. Stabilizing the blade and performing sharpening to consistency and accuracy becomes rather difficult.

Given these previous challenges listed, it is very important to make sure a sharpening robot is stable while conducting sharpening and/or maintenance of lawn mower blade(s) and/or lawn mower deck assembly while the lawn mower blade(s) are attached to the lawn mower and/or attached to another mechanism. Having the ability for a sharpening and/or task robot to dock and/or mate and be stabilized on a lawn mower blade(s) and/or any part of the lawn mower deck assembly and/or ground and/or any surface underneath a lawn mower and/or spindle while the lawn mower blade(s) is attached to a lawn mower is essential.

### SUMMARY

Provided is a docking system for docking a robot relative to a lawn mower. In some non-limiting embodiments, the system may further include a drive system configured to move the robot, a sensor, a docking arm, and/or at least one processor operatively connected to the drive system, the sensor, and/or the docking arm. In some non-limiting embodiments, the at least one processor may be configured to receive a signal from the sensor, the signal including data from a first location of the robot. In some non-limiting embodiments, the at least one processor may be configured to control the drive system to drive from the first location to a second location based on receiving the signal from the sensor. In some non-limiting embodiments, the at least one processor may be configured to control the docking arm to dock at the second location. In some non-limiting embodiments, the robot may be configured to perform a task associated with the lawn mower at the second location. In some non-limiting embodiments, the at least one processor may be configured to control the docking arm to un-dock the robot from the second location upon completion of the task associated with the lawn mower.

In some non-limiting embodiments, the docking arm may include a first end connected to the robot and a second end. In some non-limiting embodiments, the second end may be connected to a coupling mechanism. The coupling mechanism may be operatively connected to the at least one processor. In some non-limiting embodiments, the at least one processor may be further configured to control the coupling mechanism to couple the robot to the lawn mower, where the coupling mechanism may include a magnet, and where the coupling mechanism may be configured to magnetically attach the robot to the lawn mower.

In some non-limiting embodiments, the docking arm may include a first end connected to the robot and a second end. The second end may be connected to a coupling mechanism. The coupling mechanism may be operatively connected to the at least one processor. In some non-limiting embodiments, the at least one processor may be further configured to control the coupling mechanism to couple the robot to the lawn mower, wherein the coupling mechanism may include a clamp, and where the coupling mechanism may be configured to clamp the robot to the lawn mower.

In some non-limiting embodiments, the docking arm may include a first end connected to the robot and a second end. The second end may be connected to a coupling mechanism. The coupling mechanism may be operatively connected to the at least one processor. In some non-limiting embodiments, the at least one processor may be further configured to control the coupling mechanism to couple the robot to the lawn mower, where the coupling mechanism may include a suction device, and where the coupling mechanism may be configured to suction the robot to the lawn mower.

In some non-limiting embodiments, the at least one processor may be further configured to control the drive system to drive from the second location to a third location in response to controlling the docking arm to un-dock the robot from the second location.

In some non-limiting embodiments, when controlling the docking arm to dock the robot at the second location, the at least one processor may be configured to determine a location of a blade of the lawn mower and/or control the docking arm to dock the robot to lawn mower at the location of the blade of the lawn mower.

In some non-limiting embodiments, the docking system may further include a task arm, where the task arm may be operatively connected to the at least one processor. In some non-limiting embodiments, the at least one processor may be further configured to control the task arm to complete the task associated with the lawn mower, where the task may include sharpening a blade of the lawn mower.

In some non-limiting embodiments, the at least one processor may be configured to control the docking arm to move in an upward direction, a downward direction, and/or rotate. In some non-limiting embodiments, where the docking arm may be static.

In some non-limiting embodiments, the drive system may include at least one second processor, and where the at least one second processor may be configured to receive data from the at least one processor, the data comprising instructions to drive from the first location to the second location and/or drive the robot from the first location to the second location in response to receiving the instructions.

In some non-limiting embodiments, provided is a method for docking a robot relative to a lawn mower. In some non-limiting embodiments, the robot may include a drive system configured to move the robot, a sensor, a docking arm, and at least one processor operatively connected to the drive system, the sensor, and/or the docking arm. In some non-limiting embodiments, the method may include receiving, by the at least one processor the signal comprising data from a first location of the robot. In some non-limiting embodiments, the method may include controlling the drive system to drive from the first location to a second location based on receiving the signal from the sensor. In some non-limiting embodiments, the method may include controlling the docking arm to dock the robot at the second location. In some non-limiting embodiments, the robot may be configured to perform a task associated with the lawn mower at the second location. In some non-limiting embodiments, the method may include controlling the docking arm to un-dock the robot upon completion of the task associated with the lawn mower.

In some non-limiting embodiments, the docking arm may include a first end connected to the robot and a second end. The second end may be connected to a coupling mechanism. The coupling mechanism may be operatively connected to the at least one processor. In some non-limiting embodiments, the method may further include controlling the coupling mechanism to couple the robot to the lawn mower, where the coupling mechanism may include a magnet, and where the coupling mechanism may be configured to magnetically attach the robot to the lawn mower.

In some non-limiting embodiments, the docking arm may include a first end connected to the robot and a second end. The second end may be connected to a coupling mechanism. The coupling mechanism may be operatively connected to the at least one processor. In some non-limiting embodiments, the method may further include controlling the coupling mechanism to couple the robot to the lawn mower, where the coupling mechanism may include a clamp, and where the coupling mechanism may be configured to clamp the robot to the lawn mower.

In some non-limiting embodiments, the docking arm may include a first end connected to the robot and a second end. The second end may be connected to a coupling mechanism. The coupling mechanism may be operatively connected to the at least one processor. In some non-limiting embodiments, the method may further include controlling the coupling mechanism to couple the robot to the lawn mower, where the coupling mechanism may include a suction device, and where the coupling mechanism may be configured to suction the robot to the lawn mower.

In some non-limiting embodiments, the method may further include controlling the drive system to drive from the second location to a third location in response to controlling the docking arm to un-dock the robot from the second location.

In some non-limiting embodiments, controlling the docking arm to dock the robot at the second location may include determining a location of a blade of the lawn mower and/or controlling the docking arm to dock the robot to lawn mower at the location of the blade of the lawn mower.

In some non-limiting embodiments, the robot may further include a task arm. The task arm may be operatively connected to the at least one processor. In some non-limiting embodiments, the at least one method may include controlling the task arm to complete the task associated with the lawn mower, where the task may include sharpening a blade of the lawn mower.

In some non-limiting embodiments, the method may include controlling the docking arm to move in an upward direction, a downward direction, and/or rotate.

In some non-limiting embodiments, the docking arm may be static.

In some non-limiting embodiments, the drive system may include at least one second processor. In some non-limiting embodiments, the method may further include receiving, by at least one second processor of the drive system data from the at least one processor, the data comprising instructions to drive from the first location to the second location and/or driving, by at least one second processor of the drive system, the robot from the first location to the second location in response to receiving the instructions.

Further non-limiting embodiments are set forth in the following numbered clauses:

Clause 1: A docking system for docking a robot relative to a lawn mower, comprising: a drive system configured to move the robot; a sensor; a docking arm; and at least one processor operatively connected to the drive system, the sensor, and the docking arm, the at least one processor configured to: receive a signal from the sensor, the signal comprising data from a first location of the robot; control the drive system to drive from the first location to a second location based on receiving the signal from the sensor; control the docking arm to dock the at the second location, wherein the robot is configured to perform a task associated with the lawn mower at the second location; and control the docking arm to un-dock the robot from the second location upon completion of the task associated with the lawn mower.

Clause 2: The docking system of clause 1, wherein the docking arm comprises a first end connected to the robot and a second end, wherein the second end is connected to a coupling mechanism, wherein the coupling mechanism is operatively connected to the at least one processor, and wherein the at least one processor is further configured to: control the coupling mechanism to couple the robot to the lawn mower, wherein the coupling mechanism comprises a magnet, and wherein the coupling mechanism is configured to magnetically attach the robot to the lawn mower.

Clause 3: The docking system of clause 1 or 2, wherein the docking arm comprises a first end connected to the robot and a second end, wherein the second end is connected to a coupling mechanism, wherein the coupling mechanism is operatively connected to the at least one processor, and wherein the at least one processor is further configured to: control the coupling mechanism to couple the robot to the lawn mower, wherein the coupling mechanism comprises a clamp, and wherein the coupling mechanism is configured to clamp the robot to the lawn mower.

Clause 4: The docking system of any of clauses 1-3, wherein the docking arm comprises a first end connected to the robot and a second end, wherein the second end is connected to a coupling mechanism, wherein the coupling mechanism is operatively connected to the at least one processor, and wherein the at least one processor is further configured to: control the coupling mechanism to couple the robot to the lawn mower, wherein the coupling mechanism comprises a suction device, and wherein the coupling mechanism is configured to suction the robot to the lawn mower.

Clause 5: The docking system of any of clauses 1-4, wherein the at least one processor is further configured to: control the drive system to drive from the second location to a third location in response to controlling the docking arm to un-dock the robot from the second location.

Clause 6: The docking system of any of clauses 1-5, wherein, when controlling the docking arm to dock the robot at the second location, the at least one processor is configured to: determine a location of a blade of the lawn mower; and control the docking arm to dock the robot to lawn mower at the location of the blade of the lawn mower.

Clause 7: The docking system of any of clauses 1-6, further comprising a task arm, wherein the task arm is operatively connected to the at least one processor, wherein the at least one processor is further configured to: control the task arm to complete the task associated with the lawn mower, wherein the task comprises sharpening a blade of the lawn mower.

Clause 8: The docking system of any of clauses 1-7, wherein the at least one processor is configured to control the docking arm to move in an upward direction, a downward direction, and/or rotate.

Clause 9: The docking system of any of clauses 1-8, wherein the docking arm is static.

Clause 10: The docking system of any of clauses 1-9, wherein the drive system comprises at least one second processor, and wherein the at least one second processor is configured to: receive data from the at least one processor, the data comprising instructions to drive from the first location to the second location; and drive the robot from the first location to the second location in response to receiving the instructions.

Clause 11: A method for docking a robot relative to a lawn mower, the robot comprising: a drive system configured to move the robot; a sensor; a docking arm; and at least one processor operatively connected to the drive system, the sensor, and the docking arm; the method comprising: receiving, by the at least one processor, a signal from the sensor, the signal comprising data from a first location of the robot; controlling, by the at least one processor, the drive system to drive from the first location to a second location based on receiving the signal from the sensor; controlling, by the at least one processor, the docking arm to dock the robot at the second location, wherein the robot is configured to perform a task associated with the lawn mower at the second location; and controlling, by the at least one processor, the docking arm to un-dock the robot upon completion of the task associated with the lawn mower.

Clause 12: The method of clause 11, wherein the docking arm comprises a first end connected to the robot and a second end, wherein the second end is connected to a coupling mechanism, wherein the coupling mechanism is operatively connected to the at least one processor, the method further comprising: controlling the coupling mechanism to couple the robot to the lawn mower, wherein the coupling mechanism comprises a magnet, and wherein the coupling mechanism is configured to magnetically attach the robot to the lawn mower.

Clause 13: The method of clause 11 or 12, wherein the docking arm comprises a first end connected to the robot and a second end, wherein the second end is connected to a coupling mechanism, wherein the coupling mechanism is operatively connected to the at least one processor, the method further comprising: controlling the coupling mechanism to couple the robot to the lawn mower, wherein the coupling mechanism comprises a clamp, and wherein the coupling mechanism is configured to clamp the robot to the lawn mower.

Clause 14: The method of any of clauses 11-13, wherein the docking arm comprises a first end connected to the robot and a second end, wherein the second end is connected to a coupling mechanism, wherein the coupling mechanism is operatively connected to the at least one processor, the method further comprising: controlling the coupling mechanism to couple the robot to the lawn mower, wherein the coupling mechanism comprises a suction device, and wherein the coupling mechanism is configured to suction the robot to the lawn mower.

Clause 15: The method of any of clauses 11-14, further comprising: controlling, by the at least one processor, the drive system to drive from the second location to a third location in response to controlling the docking arm to un-dock the robot from the second location.

Clause 16: The method of any of clauses 11-15, wherein, controlling the docking arm to dock the robot at the second location further comprises: determining a location of a blade of the lawn mower; and controlling the docking arm to dock the robot to lawn mower at the location of the blade of the lawn mower.

Clause 17: The method of any of clauses 11-16, wherein the robot further comprises a task arm, wherein the task arm is operatively connected to the at least one processor, and wherein the method further comprises: controlling, by the at least one processor, the task arm to complete the task associated with the lawn mower, wherein the task comprises sharpening a blade of the lawn mower.

Clause 18: The method of any of clauses 11-17, further comprising: controlling the docking arm to move in an upward direction, a downward direction, and/or rotate.

Clause 19: The method of any of clauses 11-18, wherein the docking arm is static.

Clause 20: The method of any of clauses 11-19, wherein the drive system comprises at least one second processor, the method further comprising: receiving, by at least one second processor of the drive system data from the at least one processor, the data comprising instructions to drive from the first location to the second location; and driving, by at least one second processor of the drive system, the robot from the first location to the second location in response to receiving the instructions.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for docking a robot relative to a lawn mower, according to some non-limiting embodiments;

FIG. 2 is a flow diagram of a method for docking a robot relative to a lawn mower, according to some non-limiting embodiments;

FIGS. 3A and 3B are diagrams of a robot, according to some non-limiting embodiments;

FIG. 3C is a schematic diagram of example hardware components of the robot in FIGS. 3A and 3B, according to some non-limiting embodiments;

FIG. 4 is a diagram of a lawn mower, according to some non-limiting embodiments;

FIGS. 5A-5C are diagrams of the system of FIG. 1, according to some non-limiting embodiments;

FIGS. 6A-6G are diagrams of example docking arms, according to some non-limiting embodiments;

FIGS. 7A-7G are diagrams of example docking locations, according to some non-limiting embodiments;

FIGS. 8A-8E are diagrams of example coupling mechanisms, according to some non-limiting embodiments;

FIG. 9 is a diagram of a robot with a docking arm and coupling mechanism, according to some non-limiting embodiments;

FIG. 10 is a diagram of a docking system unit, according to some non-limiting embodiments; and

FIG. 11 is a schematic diagram of the docking system unit of FIG. 10, according to some non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments of the disclosed subject matter. Hence, specific dimensions and other physical characteristics related to the embodiments disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments, refer to a condition for automatically triggering an action (e.g., a specific operation of an electronic device, such as a computing device, a processor, and/or the like).

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

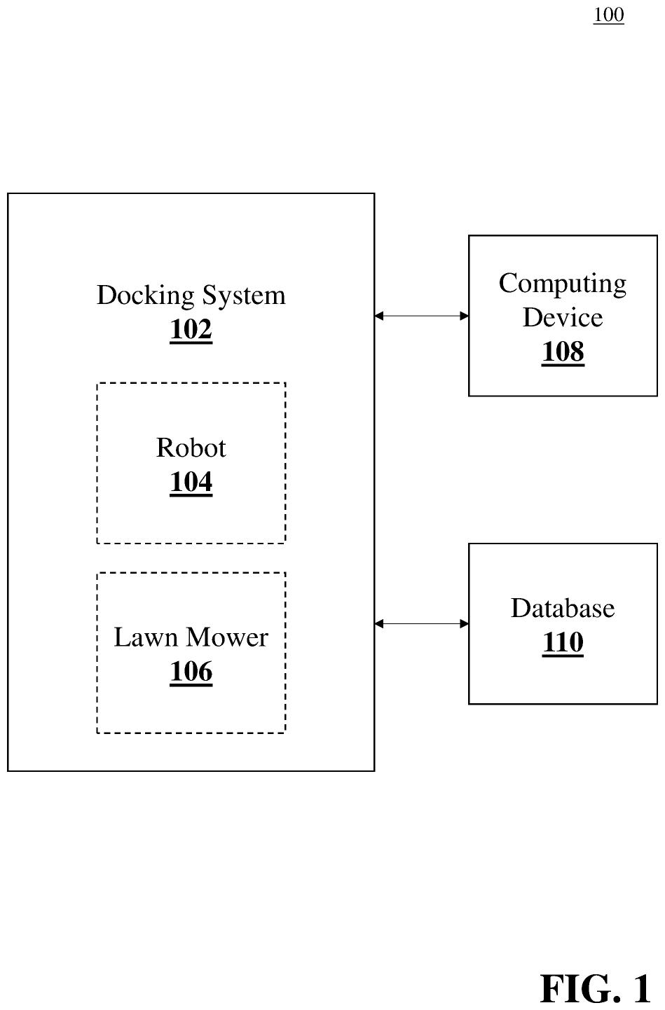

Referring now to FIG. 1, shown is a schematic diagram of a system 100 for a robot configured to orient the robot relative to a lawn mower, according to some non-limiting embodiments. System 100 may include docking system 102, computing device 108, and/or database 110. Docking system 102, computing device 108, and/or database 110 may interconnect (e.g., establish a connection to communicate) via wired connections, wireless connections, or a combination of wired and wireless connections.

Docking system 102 may include one or more devices configured to communicate with computing device 108 and/or database 110. For example, docking system 102 may include a server, a group of servers, and/or other like devices. In some non-limiting embodiments, docking system 102 may be in communication with a data storage device (e.g., database 110), which may be local or remote to docking system 102. In some non-limiting embodiments, docking system 102 may be capable of receiving information from, storing information in, transmitting information to, and/or searching information stored in the data storage device (e.g., database 110). In some non-limiting embodiments, docking system 102 may include lawn mower robot 104 and/or lawn mower 106.

Robot 104 may include a computing device, as described herein. Robot 104 may include one or more devices configured to communicate with computing device 108 and/or database 110. In some non-limiting embodiments, robot 104 may be in communication with a data storage device (e.g., database 110), which may be local or remote to robot 104. In some non-limiting embodiments, robot 104 may be capable of receiving information from, storing information in, transmitting information to, and/or searching information stored in the data storage device (e.g., database 110). In some non-limiting embodiments, robot 104 may include an autonomous lawn mower blade sharpening and task apparatus, as described in U.S. Patent Application Publication No. US-2021-0007281-A1, filed on Jul. 14, 2020, the disclosure of which is hereby incorporated by reference in its entirety.

In some non-limiting embodiments, lawn mower 106 may be any type of lawn mower configured to cut grass (e.g., manual push, electric, riding, etc.). In some non-limiting embodiments, lawn mower 106 may include a plurality of components. In some non-limiting embodiments, lawn mower 106 may include a Radio Frequency Identification (RFID) (e.g., a tag or embedding) which may be scanned and/or read by docking system 102, robot 104, computing device 108, and/or database 110.

Computing device 108 may include a computing device configured to communicate with docking system 102 and/or database 110 (e.g., via a wired or wireless connection). For example, computing device 108 may include a computing device, such as a server, a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments, system 100 may include one or more subsequent computing devices that are the same as, similar to, and/or part of computing device 108.

Database 110 may include one or more devices configured to communicate with docking system 102 and/or computing device 108 (e.g., via a wired or wireless connection). For example, database 110 may include a computing device, such as a server, a group of servers, and/or other like devices.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

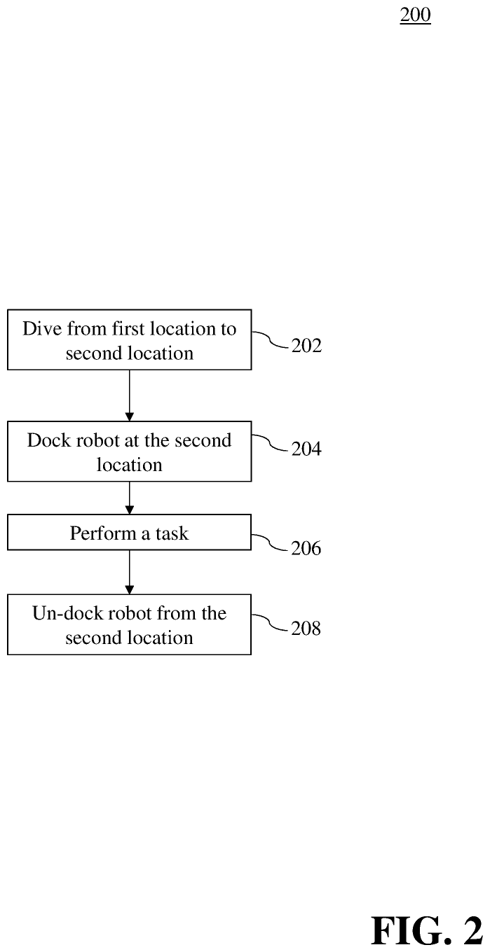

Referring to FIG. 2, shown is a flow diagram of a method 200 for docking robot 104 relative to lawn mower 106, according to some non-limiting embodiments. In some non-limiting embodiments, one or more steps of method 200 may be performed (e.g., completely, partially, etc.) by docking system 102 (e.g., one or more devices of docking system 102). In some non-limiting embodiments, one or more steps of method 200 may be performed (e.g., completely, partially, etc.) by another device or group of devices separate from or docking system 102.

In some non-limiting embodiments, docking system 102 may include at least one processor. For example, robot 104 may include at least one processor. In some non-limiting embodiments, robot 104 may include a drive system configured to move the robot and/or at least one sensor. In some non-limiting embodiments, the at least one processor may be operatively connected to the drive system and/or the at least one sensor. In some non-limiting embodiments, the at least one processor may be configured to control the drive system and/or the at least one sensor. In some non-limiting embodiments, the drive system and/or the at least one sensor may include at least one second processor.

In some non-limiting embodiments, docking system 102 may generate and/or communicate instructions (e.g., to robot 104). For example, docking system 102 may generate and/or communicate instructions comprising data instructing robot 104 to activate (e.g., turn on) and/or deactivate (e.g., turn off). In some non-limiting embodiments, docking system 102 may activate robot 104. Robot 104 may be activated in a first location, where the first location is adjacent to (e.g., next to) lawn mower 106. The first location may be a location relative to lawn mower 106 (e.g., to the left, right, front, and/or back of lawn mower 106).

In some non-limiting embodiments, lawn mower 106 may include a plurality of components. The plurality of components may include at least one of a body, a lawn mower deck, a discharge chute, a wheel, and/or a blade. In some non-limiting embodiments, lawn mower 106 may include six sides (e.g., a front, a back, a top, a bottom, a left, and a right). In some non-limiting embodiments, lawn mower 106 may include a Radio Frequency Identification (RFID). For example, an RFID chip may be attached to and/or embedded in one or more components of lawn mower 106. In some non-limiting embodiments, robot docking system 102 may scan and/or read the RFID chip of lawn mower 106.

In some non-limiting embodiments, docking system 102 may detect, generate, and/or communicate at least one signal. For example, robot 104 may include at least one sensor configured to detect, generate, and/or communicate (e.g., to the at least one processor) at least one signal and/or data associated with the at least one signal. In some non-limiting embodiments, docking system 102 may control the at least one sensor to detect, generate, and/or communicate the at least one signal and/or data associated with the at least one signal.

In some non-limiting embodiments, docking system 102 may detect a first signal associated with at least one first component of the plurality of components of the lawn mower. For example, the at least one sensor of robot 104 may detect the first signal at the first location (e.g., to the front, back, right, or left of lawn mower 106).

In some non-limiting embodiments, the at least one first component may include a body of the lawn mower, a deck of the lawn mower, a discharge chute of the lawn mower, a wheel of the lawn mower, a blade of the lawn mower, and/or any other component of the lawn mower. In some non-limiting embodiments, docking system 102 may determine a position of robot 104 (e.g., relative to lawn mower 106) and/or lawn mower 106 (e.g., relative to robot 104) based on the at least one first component.

In some non-limiting embodiments, docking system 102 may determine first object data associated with the at least one first component of the plurality of components of the lawn mower based on the first signal received from the at least one sensor. For example, docking system 102 may determine the first object data associated with the at least one first component of the plurality of components of the lawn mower based on the first signal received from the at least one sensor.

In some non-limiting embodiments, the first object data may include a dimension (e.g., a length, a width, and/or a height) of the at least one first component, a distance between robot 104 and the at least one first component, a location of the at least one first component, a type of component of the at least one first component, a task associated with the at least one first component, and/or other details associated with the at least one first component.

In some non-limiting embodiments, docking system 102 may include at least one camera. For example, robot 104 may include the at least one camera. In some non-limiting embodiments, the at least one processor may be operatively connected to the at least one camera. In some non-limiting embodiments, the at least one processor may be configured to control the at least one camera. In some non-limiting embodiments, the at least one camera may include at least one second processor.

In some non-limiting embodiments, docking system 102 may capture first object data associated with at least one first component of the plurality of components of the lawn mower (e.g., in response to detecting the first object data associated with at least one first component of the plurality of components of the lawn mower). For example, docking system 102 may control the at least one camera to capture the first object data.

In some non-limiting embodiments, docking system 102 may query a database, the database including a plurality of existing object data records. The existing object data records may include data associated with the plurality of components of lawn mower 106 and/or a second plurality of components associated with a plurality of lawn mowers. In some non-limiting embodiments, docking system 102 may query the database to determine whether or not the first object data associated with the at least one first component of the plurality of components of the lawn mower matches at least one existing object data record of the plurality of existing object data records. In some non-limiting embodiments, docking system 102 may query the at least one database based on the first signal received from the at least one sensor and/or based on the first object data captured by the at least one camera.

In some non-limiting embodiments, docking system 102 may compare the first object data (e.g., one or more features of the first object data) to the plurality of existing object data records (e.g., to one or more features of the plurality of existing object data records) to identify a match and/or a partial match. In some non-limiting embodiments, docking system 102 may determine whether or not the first object data associated with the at least one first component of the plurality of components of the lawn mower matches at least one existing object data record of the plurality of existing object data records based on the comparison. In some non-limiting embodiments, if docking system 102 identifies a match, then docking system 102 may determine that the first object data associated with the at least one first component of the plurality of components of the lawn mower matches at least one existing object data record of the plurality of existing object data records. In some non-limiting embodiments, if docking system 102 does not identify a match, then docking system 102 may determine that the first object data associated with the at least one first component of the plurality of components of the lawn mower does not match at least one existing object data record of the plurality of existing object data records.

In some non-limiting embodiments, if docking system 102 determines that the first object data associated with the at least one first component of the plurality of components of the lawn mower matches the at least one existing object data record of the plurality of existing object data records, then docking system 102 may determine a second location. For example, if docking system 102 determines that the first object data matches at least one existing object data record (e.g., docking system 102 recognizes an environment surrounding robot 104), then docking system 102 may determine a second location (e.g., different from the first location) and control robot 104 to move to the second location. In some non-limiting embodiments, the second location may be relative to lawn mower 106 (e.g., a location underneath the bottom side of lawn mower 106).

In some non-limiting embodiments, if docking system 102 determines that the first object data associated with the at least one first component of the plurality of components of the lawn mower does not match the at least one existing object data record of the plurality of existing object data records, then docking system 102 may generate an object data record comprising the first object data associated with the at least one first component of the plurality of components of the lawn mower. In some non-limiting embodiments, docking system 102 may update (e.g., automatically) the plurality of existing object data records to include the object data record comprising the first object data associated with the at least one first component of the plurality of components of the lawn mower to provide an updated plurality of existing object data records. In some non-limiting embodiments, docking system 102 may determine the second location based on the updated plurality of existing object data records.

As shown in FIG. 2, at step 202, method 200 may include driving from the first location to the second location. For example, robot 104 may drive from the first location to the second location based on the first object data. In some non-limiting embodiments, docking system 102 may control the drive system to drive robot 104 from the first location to the second location based on the first object data. In some non-limiting embodiments, the second location may include a location underneath a second side (e.g., the bottom) of lawn mower 106. In some non-limiting embodiments, one or more components of lawn mower 106 (e.g., the blades) may only be accessible to robot 104 from a location underneath the second side (e.g., the bottom) of lawn mower 106.

In some non-limiting embodiments, the at least one second processor of the drive system may receive data from docking system 102 including instructions to drive from the first location to the second location. In some non-limiting embodiments, the drive system may be configured to drive the robot from the first location to the second location in response to receiving the instructions. In some non-limiting embodiments, the drive system may include at least one of a motor, a wheel, a ball, a track, and/or any combination thereof.

In some non-limiting embodiments, docking system 102 may detect a second signal associated with at least one second component of the plurality of components of the lawn mower. For example, the at least one sensor of robot 104 may detect the second signal at the second location. In some non-limiting embodiments, the at least one second component may include a body, a deck, a discharge chute, a wheel, a blade and/or any other component of lawn mower 106.

As shown in FIG. 2, at step 206, docking system 102 may determine the second object data. For example, docking system 102 may determine the second object data associated with the at least one second component of the plurality of components of the lawn mower based on the second signal received from the at least one sensor and/or based on the second object data captured by the at least one camera.

In some non-limiting embodiments, the second object data may include a dimension (e.g., a length, a width, and/or a height) of the at least one second component, a distance between robot 104 and the at least one second component, a location of the at least one second component, a type of component of the at least one second component, a task associated with the at least one second component, and/or other details associated with the at least one second component.

In some non-limiting embodiments, docking system 102 may capture (e.g., using the at least one camera) second object data associated with at least one second component of the plurality of components of lawn mower 106, as described herein. In some non-limiting embodiments, docking system 102 may capture the second object data associated with at least one second component of the plurality of components of lawn mower 106 in response to detecting the second object data associated with at least one second component of the plurality of components of the lawn mower.

In some non-limiting embodiments, docking system 102 may query the database to determine whether or not the second object data associated with the at least one second component of the plurality of components of the lawn mower matches at least one existing object data record of the plurality of existing object data records, as described herein.

In some non-limiting embodiments, if docking system 102 determines that the second object data associated with the at least one second component of the plurality of components of the lawn mower matches the at least one existing object data record of the plurality of existing object data records, then docking system 102 may determine a third location underneath the bottom side of the lawn mower. In some non-limiting embodiments, the second location and/or the third location may be the location where a task may be completed.

In some non-limiting embodiments, the third location may be a location that is different from the second location or the same as the second location (e.g., robot 104 will not move). In some non-limiting embodiments, the third location may be a location that is the same as the first location (e.g., robot 104 will return from the second location to the first location if docking system 102 determines that the task does not need to be completed based on the first object data and/or the second object data).

In some non-limiting embodiments, if docking system 102 determines that the second object data associated with the at least one second component of the plurality of components of the lawn mower does not match the at least one existing object data record of the plurality of existing object data records, then docking system 102 may generate an object data record comprising the second object data associated with the at least one second component of the plurality of components of the lawn mower. In some non-limiting embodiments, docking system 102 may update the plurality of existing object data records to include the object data record comprising the second object data associated with the at least one second components of the plurality of components of the lawn mower to provide an updated plurality of existing object data records. In some non-limiting embodiments, docking system 102 may determine the third location underneath the second side of lawn mower 106 based on the updated plurality of existing object data records.

In some non-limiting embodiments, docking system 102 may detect a plurality of signals associated with the plurality of components of lawn mower 106, as described herein. In some non-limiting embodiments, docking system 102 may capture object data associated with the plurality of components of lawn mower 106, as described herein.

As shown in FIG. 2, at step 204, method 200 may include docking robot 104 at the second location. For example, docking system 102 may control the docking arm to dock at the second location and/or the third location.

In some non-limiting embodiments, the docking arm may include a first end connected to robot 104 and a second end, where the second end is connected to a coupling mechanism. The coupling mechanism may be operatively connected to the at least one processor of docking system 102. In some non-limiting embodiments, docking system 102 may control the coupling mechanism to couple (e.g., attach to) the lawn mower. In some non-limiting embodiments, the coupling mechanism may include one of: a magnet, a clamp, a claw, and/or a suction device. In some non-limiting embodiments, the coupling device may be configured to magnetically attach, suction, clamp, and/or lock the robot to the lawn mower.

In some non-limiting embodiments, docking the robot at the second location may include determining a location and/or position of the blade of the lawn mower and/or the lawn mower deck. In some non-limiting embodiments, robot 104 may be configured to dock at a location relative to the blade of the lawn mower (e.g., on a surface of the blade of the lawn mower) and/or the lawn mower deck (e.g., one a surface of the lawn mower deck).

As shown in FIG. 2, at step 206, docking system 102 may perform a task. In some non-limiting embodiments, docking system 102 may control robot 104 to perform the task based on the first object data associated with the at least one first component of the plurality of components of lawn mower 106 and/or the second object data associated with the at least one second component of the plurality of components of lawn mower 106. In some non-limiting embodiments, the task may include a series of tasks (e.g., sharpening the blades of lawn mower 106 and/or other lawn mower service and/or maintenance tasks).

In some non-limiting embodiments, robot 104 may include at least one task arm configured to perform the task. In some non-limiting embodiments, the at least one task arm may be operatively connected to the at least one processor. In some non-limiting embodiments, the at least one task arm may include at least one second processor. The at least one task arm may be removable, static, and/or motorized. Docking system 102 may control the at least one task arm to perform the task. In some non-limiting embodiments, the task may include sharpening at least one blade of lawn mower 106. For example, docking system 102 may control the task arm of robot 104 to sharpen at least one blade of lawn mower 106.

As shown in FIG. 2, at step 208, method 200 may include un-docking robot 104 from the second location. For example, docking system 102 may control the docking arm to un-dock the robot from the second location in response to completing the task associated with the lawn mower. In some non-limiting embodiments, docking system 102 may control the coupling mechanism to de-couple (e.g., release from) the lawn mower.

In some non-limiting embodiments, docking system 102 may control the drive system to drive from the second location to a third location in response to de-coupling the robot and the lawn mower. In some non-limiting embodiments, the third location may be the same as the first location.

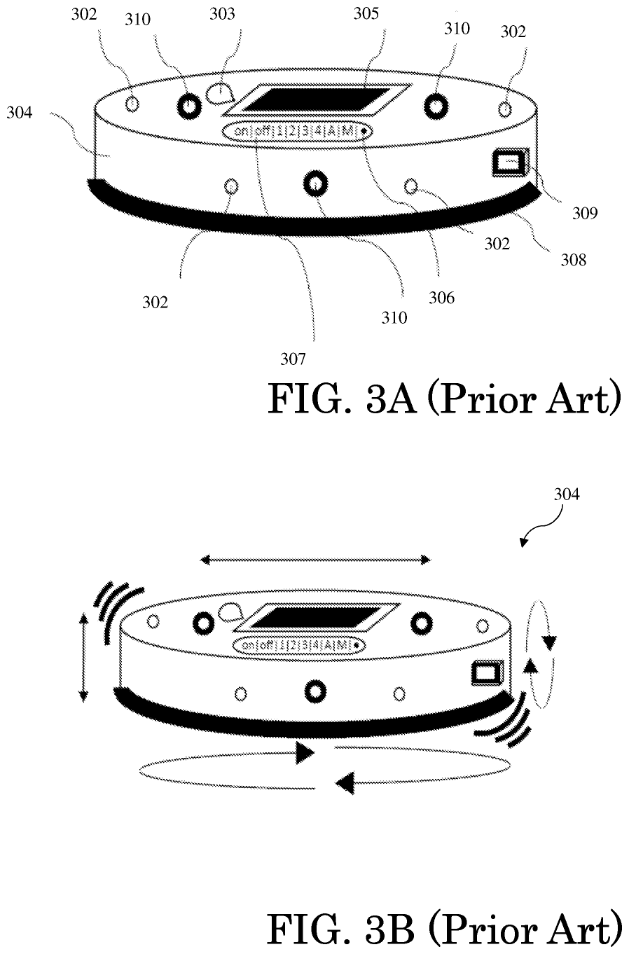

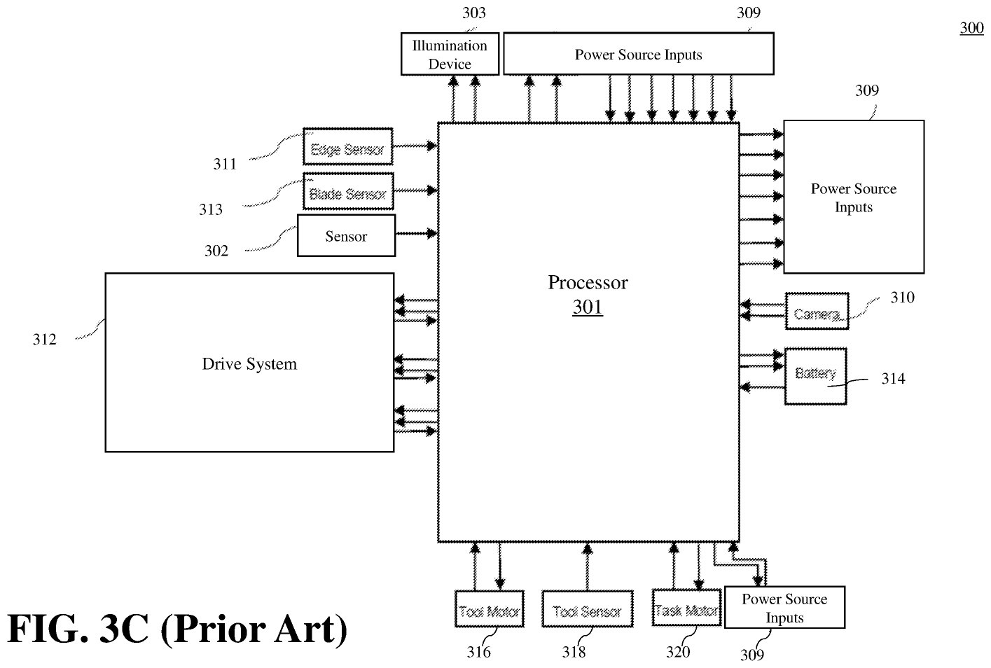

FIGS. 3A and 3B are diagrams of robot 304, according to some non-limiting embodiments. In some non-limiting embodiments, robot 304 may be the same as, similar to, and/or part of robot 104. In some non-limiting embodiments, robot 304 may include a plurality of components. In some non-limiting embodiments, the plurality of components may be operatively connected to at least one processor. In some non-limiting embodiments, the plurality of components may be configured to receive data from and/or communicate data to the at least one processor. In some non-limiting embodiments, the plurality of components of robot 304 may include sensor 302, illumination device 303, base 305, indicator 306, panel 307, duster 308, and power source input 309, and/or at least one camera 310.

In some non-limiting embodiments, sensor 302 may include one or more sensors. The one or more sensors may include light detection and ranging (LiDAR) sensor(s), time-of-Flight (ToF) sensor(s), proximity sensor(s), optical sensor(s), image sensor(s), or any combination thereof. In some non-limiting embodiments, sensor 302 may detect at least one signal. For example, sensor 302 may be configured to detect at least one signal associated with at least one component of a plurality of components of lawn mower 106. In some non-limiting embodiments, sensor 302 may be operatively connected to at least one processor. In some non-limiting embodiments, sensor 302 may be configured to communicate the at least one signal to the at least one processor.

In some non-limiting embodiments, illumination device 303 may include a light (e.g., an LED light) and/or a speaker. Illumination device 303 may be configured to generate, transmit, and/or receive data (e.g., visualization, voice commands, and/or loud noise response). For example there is a loud noise, such as lawn mower 106 starting up or running, the robot 304 may be configured to autonomously drive away from lawn mower 106.

In some non-limiting embodiments, base 305 may include a task tool (e.g., a task arm) and/or solar panel. In some non-limiting embodiments, base 305 may be replaceable, modular, motorized, and/or static. In some non-limiting embodiments, base 305 may include a depression configured to catch any falling debris, thereby providing for easy cleaning and less debris spread, as well as a location to store task tools and task tips not in use.

In some non-limiting embodiments, indicator 306 may include an LED light. Indicator 306 may be configured to light up to indicate various possible features of the robot 304, such as, e.g., robot power, program(s), settings, task input, and/or mode.

In some non-limiting embodiments, panel 307 may include buttons, battery power, signal strength, dials, and/or other indications which will provide various options for programs, settings, on/off, LED, and/or user inputs.

In some non-limiting embodiments, duster 308 may be configured to capture and/or move debris. Duster 308 may be configured to push debris out of the path of the robot 304 in order to keep it from becoming caught, traveling under, or otherwise inhibiting the progress of the robot 304 in all directions.

In some non-limiting embodiments, power source input 309 may be configured for use with one or more of power cables, USB cables, cable input sources, device receivers, remote receivers, external device receivers, and/or other cables to otherwise control or program robot 304 externally, wirelessly, and/or controlled by an owner/user.

In some non-limiting embodiments, camera 310 may be configured to perform an optimal alignment of task arm(s) and/or task tip(s) for precision accuracy in task(s). In some non-limiting embodiments, camera 310 may be configured to capture object data associated with a plurality of components of lawn mower 106. For example, the at least one processor may control camera 310 to capture object data associated with a plurality of components of lawn mower 106.

In some non-limiting embodiments, robot 304 may include components which may or may not be round and/or square and/or oval and/or a geometric shape and/or any shape and/or any color and/or any material and/or any height and/or any width and/or any circumference. Specifically, referring to FIG. 3A, robot 304 is shown as viewed in a normal state. Robot 304 may be formed by various shapes, sizes, colors, weights, heights, widths, and/or design.

In some non-limiting embodiments, robot 304 may include drive system 312 (shown in FIG. 3C). In some non-limiting embodiments the drive system may include one or more motors, wheels, balls, tracks, and/or any combination thereof. The drive system may include at least one brake and/or actuator. The brake and/or actuator may be configured to steer, stop, elevate, and/or descend robot 304. In some non-limiting embodiments, the brake and/or actuator may cause robot 304 to lock into place, pivot, counter act vibration (e.g., anti-vibration), and/or counter-balance.

In some non-limiting embodiments, wheels may be provided for the purposes of moving the robot in any direction at a speed. In some non-limiting embodiments, the speed may be controlled by programming, a device, and/or set by a user. Alternatively, one or more tracks may be utilized in lieu of, or in addition to, the wheels. Alternatively, a ball or track may be used in place the wheels.

As shown in FIG. 3B, robot 304 may move in any direction (e.g., front, back, diagonally, side-to-side) and/or rotate (e.g., 360 degrees). In some non-limiting embodiments, robot 304 may move around and/or encircle an object (e.g., a lawn mower 106).

In some non-limiting embodiments, robot 304 may be configured to move from a first location to a second location. In some non-limiting embodiments, robot 304 may be configured to move between, under, and/or around one or more lawn mowers.

Referring now to FIG. 3C, shown is a schematic diagram of example hardware components of robot 304, according to some non-limiting embodiments. In some non-limiting embodiments, robot 304 may include at least one processor 301. In some non-limiting embodiments, processor 301 may include an 8-bit processor. In some non-limiting embodiments, one or more components of robot 304 may include at least one second processor (not shown).

In some non-limiting embodiments, robot 304 may include one or more sensors. For example, robot 304 may include sensor 302, edge sensor 311, blade sensor 313, and/or tool sensor 318. In some non-limiting embodiments, processor 301 may be operatively connected to the one or more sensors. For example, processor 301 may be operatively connected to and/or control at least one of sensor 302, edge sensor 311, blade sensor 313, and/or tool sensor 318. In some non-limiting embodiments, at least one of sensor 302, edge sensor 311, blade sensor 313, and/or tool sensor 318 may include light detection and ranging (LIDAR) device(s), object detection system(s), Time-of-Flight (ToF) sensor(s), and/or other various sensor(s), lasers, and/or various other approximation and/or detection apparatuses, and/or any combination thereof.

Processor 301 may be operatively connected to one or more systems or devices. For example, processor 301 may be operatively connected to and/or control illumination device 303, camera 310, drive system 312 (e.g., one or more components of drive system 312), battery 314, tool motor 316, and/or ask motor 320.

Processor 301 may be operatively connected to one or more power source inputs 309 (e.g., Power LED, User Button, User Button LEDs, and USB). In some non-limiting embodiments, power source input 309 may be configured to connect to: power cables, USB cables, other cable input sources, device receivers, remote receivers, external device receivers, and/or other cables to otherwise control or program the robot externally, wirelessly, and/or controlled by an owner.

In some non-limiting embodiments, drive system 312 may be configured to move the robot in any direction at a speed controlled by programming, device, owner, and/or settings. One or more wheels, balls, and/or tracks may be provided to assist in the steering and mobile refinement for lining up robot 304 for tasks in an accurate fashion and/or general motion purposes.

In some non-limiting embodiments, edge sensor 311 may be connected to at least one task tip (not shown) of robot 304. In some non-limiting embodiments, the task tip may be integrated into the task arm, replaceable from the task arm, removable from the task arm, modular in relation to the task arm able to accommodate multiple different and/or similar task tips as a single tip and/or multiple tips at the same time and/or in conjunction with each other.

Further details regarding robot 304 (e.g., a lawn mower blade sharpening and task apparatus) are described in U.S. Patent Application Publication No. US-2021-0007281-A1, filed on Jul. 14, 2020, the disclosure of which is hereby incorporated by reference in its entirety.

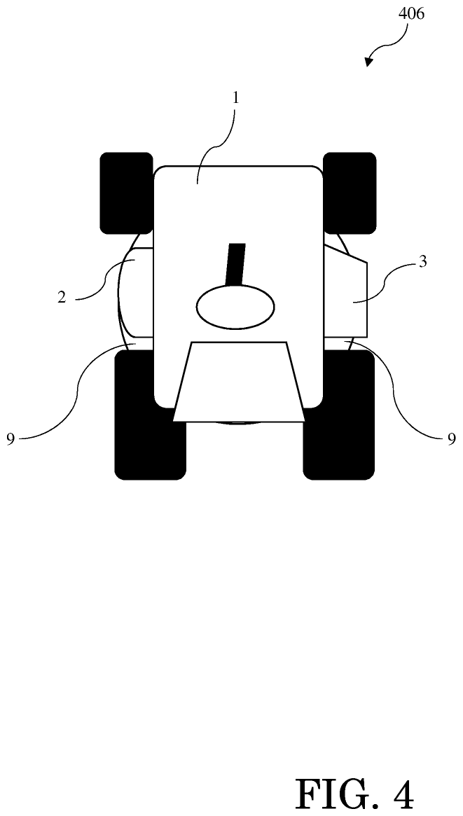

Referring now to FIG. 4, shown is a diagram of lawn mower 406, according to some non-limiting embodiments. Lawn mower 406 may be the same as, similar to, and/or part of lawn mower 106. In some non-limiting embodiments, lawn mower 406 may include body 1, deck 2, discharge chute 3, and/or wheels 12. Lawn mower 406 may be a riding mower, a push mower, an electric mower, a gas mower, a battery-powered mower, and/or any combination thereof.

In some non-limiting embodiments, body 1 may include 6 sides (e.g., a top side, a bottom side, a front side, a back side, a left side, and a right side). In some non-limiting embodiments, deck 2 and/or discharge chute 3 may be attached to body 1 (e.g., on any of the 6 sides of body 1). For example, deck 2 and/or discharge chute 3 may be attached to body 1 on any of the top side, bottom side, front side, back side, left side, and/or right side of body 1. In some non-limiting embodiments, wheels 12 may be attached to body 1 on the right and/or left side of body 1, at the front side of body 1, and/or the back side of body 1.

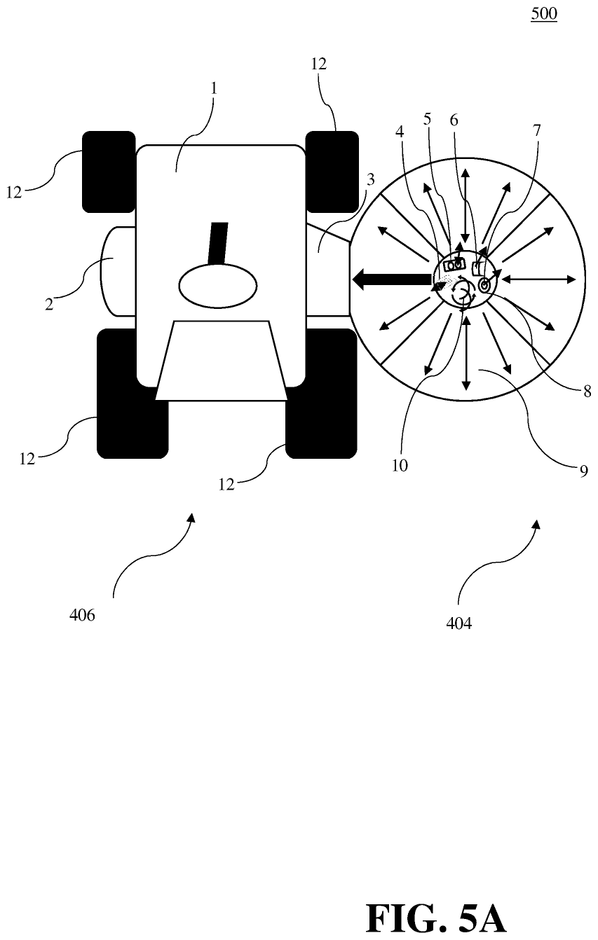

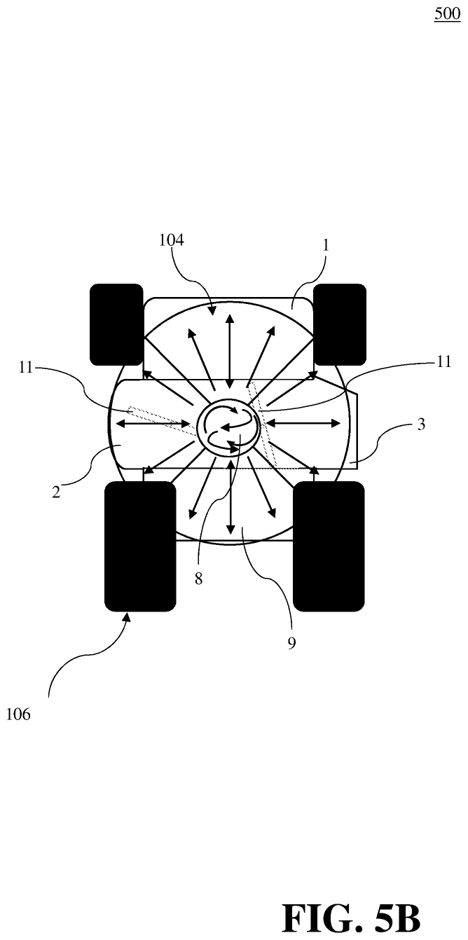

Referring now to FIGS. 5A-5C, shown are diagrams of system 500 for a robot configured to orient the robot relative to a lawn mower comprising a plurality of components, according to some non-limiting embodiments. In some non-limiting embodiments, system 500 may include robot 404 and/or lawn mower 406. In some non-limiting embodiments, robot 404 may be the same as, similar to, and/or part of robot 104 and/or robot 304.

As shown in FIG. 5A, robot 404 may include lawn mower blade sharpening and task apparatus 8. In some non-limiting embodiments, robot 404 may include system devices 4-7. For example, lawn mower blade sharpening and task apparatus 8 may include system devices 4-7. In some non-limiting embodiments, system devices 4-7 may include a light detection and ranging (LIDAR) device(s), object detection device(s), computation device(s), sensor(s), camera(s), illumination device(s), pixel(s), and/or laser(s). In some non-limiting embodiment, computation device(s) may include at least on processor and/or memory. In some non-limiting embodiments, the computation device(s) may be configured to compute algorithms. In some non-limiting embodiments, computation device(s) may include Artificial Intelligence (AI) device(s) and/or Machine Learning model(s). In some non-limiting embodiments, computation device(s) may be configured to generate one or more machine learning model(s). In some non-limiting embodiments, sensor(s) may include ToF sensor(s), and/or various sensor(s). In some non-limiting embodiments, laser(s) may include cross-hair laser(s). In some non-limiting embodiments, robot 104 may include other approximation devices, and/or other detection devices.

In some non-limiting embodiments, robot 404 may be configured to move in a plurality of directions and/or within a plurality of ranges 9. In some non-limiting embodiments, the plurality of directions and/or the plurality of ranges 9 may be specified (e.g., set by a user) and/or programmable.

In some non-limiting embodiments, robot 404 may calibrate and/or gain orientation. For example, robot 404 may calibrate and/or gain orientation based on a location of lawn mower 406. In some non-limiting embodiments, robot 404 may be configured to rotate (e.g., spin) in direction 10. For example, robot 404 may rotate (e.g., 360 degrees) in direction 10 to gain orientation and/or encircle (e.g., fully or partially) lawn mower 106 in order to gain orientation. In some non-limiting embodiments, robot 404 may maintain a single position (e.g., stay still) in order to gain orientation.

In some non-limiting embodiments, robot 104 may be activated (e.g., turned on/turned off). For example, robot 404 may be activated based on a timing (e.g., a specified time interval) and/or a positioning of robot 404. In some non-limiting embodiments, activation of system 500 may be manual, controlled via an app, controlled via app/device combination, autonomous, remote controlled (e.g., via a wired or wireless connection), and/or any combination thereof.

Robot 404 may be configured to operate within range 9 based on a location of lawn mower 406. For example, robot 404 may be configured to operate directly below the bottom side of body 1 within range 9.

FIG. 5B shows a perspective of an underside of lawn mower 406, looking up to the underside of lawn mower 406. As shown in FIG. 5B, robot 404 may operate below lawn mower 406 at the bottom side of body 1.

As shown in FIGS. 5B and 5C, lawn mower 406 may include blades 11. In some non-limiting embodiments, blades 11 may be attached to lawn mower 406 at the bottom of side body 1. In some non-limiting embodiments, lawn mower 406 may include one blade, two blades, or any number of blades. In some non-limiting embodiments, blades 11 may be attached to the bottom side of body 1 via any attachment mechanism (e.g., a screw).

In some non-limiting embodiments, robot 404 may be configured to sharpen blades 11. For example, lawn mower blade sharpening and task apparatus may be configured to sharpen blades 11. In some non-limiting embodiments, robot 404 may generate and communicate instructions to the lawn mower blade sharpening and task apparatus.

In some non-limiting embodiments, robot 404 may move from a first mower to a second mower when the first mower and the second mower are in-line, side-by-side, and/or scattered.

In some non-limiting embodiments, robot 404 may include a display. For example, robot 404 may display data associated with graphical user interface (GUI) 408 via the display. In some non-limiting embodiments, GUI 408 may be an interactive GUI. In some non-limiting embodiments, a user may input configuration data to robot 404 and/or computer device 108 via GUI 408. The configuration data may include data associated with lawn mower 406 (e.g., a position of a first lawn mower 406 relative to a second lawn mower 406).

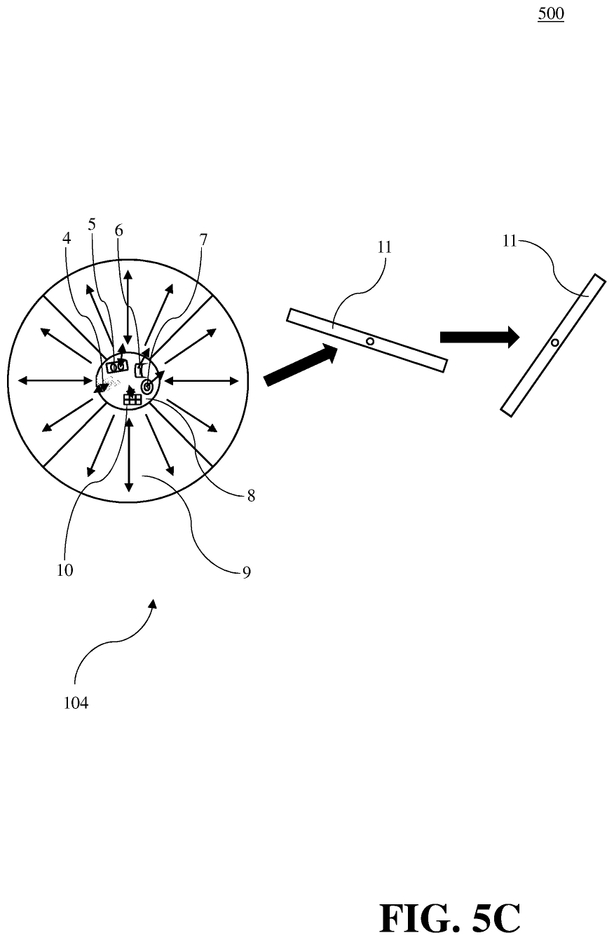

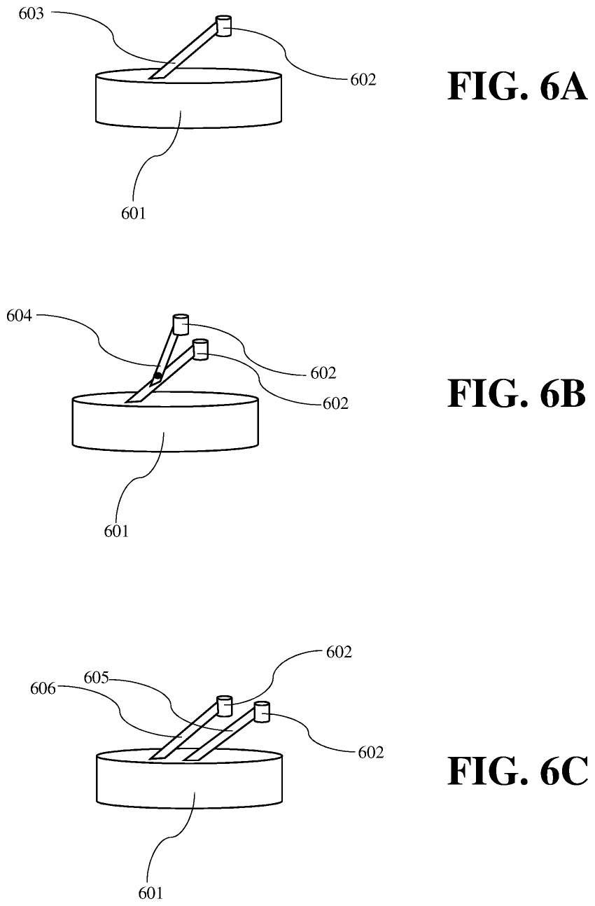

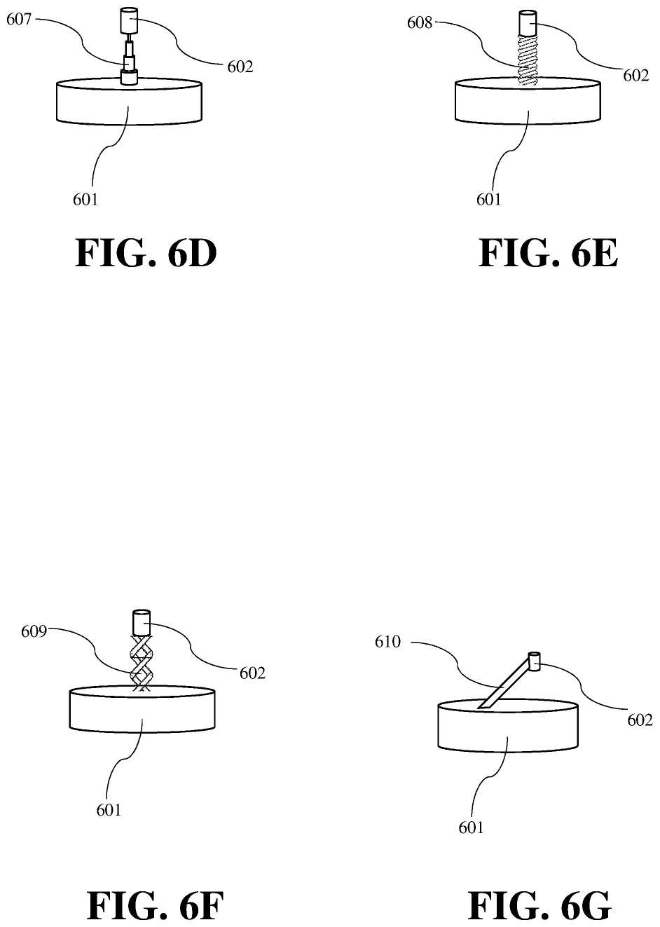

FIGS. 6A-6G are diagrams of example docking arms, according to some non-limiting embodiments. In some non-limiting embodiments, robot 601 may be the same as, similar to, and/or part of robot 304 and/or robot 104.

As shown in FIG. 6A, robot 601 may include docking arm 603. For example, docking arm 603 may be attached to a surface of a side of robot 601. In some non-limiting embodiments, docking arm 603 may be configured to move in any direction (e.g., up, down, left, right, diagonally) and/or rotate (e.g., 360 degrees). For example, docking system 102 may control docking arm 603 to move (e.g., in any direction). In some non-limiting embodiments, docking arm 603 may include at least one second processor. In some non-limiting embodiments, the at least one second processor of docking arm 603 may receive data from docking system 102 including instructions to move docking arm 603 from a first position to a second position. In some non-limiting embodiments, docking arm 603 may be a static arm (e.g., not movable). In some non-limiting embodiments, docking arm 603 may include one or more arms (shown in FIGS. 6B and 6C).

In some non-limiting embodiments, robot 601 may include dual docking arm 604. Dual docking arm 604 may be the same as, similar to, and/or part of docking arm 603. Dual docking arm 604 may include a first docking arm and a second docking arm, where the second docking arm is connected to the first docking arm. In some non-limiting embodiments, the first docking arm or the second docking arm of dual arm 604 may be configured to move. For example, docking system 102 may control the first docking arm and/or the second docking arm of dual docking arm 604 to move in an upward direction, move in a downward direction, move to the left, move to the right, and/or rotate. In some non-limiting embodiments, the first arm of dual arm 604 may move independently of the second arm of dual arm 604, and vice versa.

In some non-limiting embodiments, robot 601 may include two separate docking arms (e.g., first docking arm 605, second docking arm 606). In some non-limiting embodiments, first docking arm 605 and/or second docking arm 606 may be the same as, similar to, and/or part of docking arm 603 and/or dual docking arm 604.

As shown in FIGS. 6D-6F, robot 601 may include an expandable docking arm. The expandable docking arm may be the same as, similar to, and/or part of docking arm 603, dual docking arm 604, first docking arm 605, and/or second docking arm 606. The expandable docking arm may be configured to extend to an extended position (e.g., upward away from robot 601) and/or contract to a contracted position (e.g., downward toward robot 601).

As shown in FIG. 6D, the extendable arm may include a telescope 607. For example, telescope 607 may extend to the extended position and/or contract to the contracted position. As shown in FIG. 6E, the extendable docking arm may include threads 608. In some non-limiting embodiments, the extendable arm may be configured to be screwed into and/or unscrewed from robot 601 using threads 608. The extendable docking arm may extend to the extended position by unscrewing threads 608 to extend a length of the docking arm. In the some non-limiting embodiments, the extendable docking arm may contract to the contracted position by screwing threads 608 into robot 601 to shorten the length of the docking arm. As shown in FIG. 6F, the extendable docking arm may include a collapsible ladder 609 which may be configured to extend by moving in an upward direction (e.g., a direction away from robot 601) and/or contract by moving in a downward direction (e.g., a direction toward robot 601).

As shown in FIG. 6G, robot 601 may include static docking arm 610. In some non-limiting embodiments static docking arm 610 may include a docking arm that is static (e.g., a docking arm that is not configured to move). In some non-limiting embodiments, static docking arm 610 may be the same as, similar to, and/or part of docking arm 603, dual docking arm 604, first docking arm 605, and/or second docking arm 606.

In some non-limiting embodiments, docking arm 603 may include a first end (e.g., an end attached to robot 601) and/or a second end (e.g., an end away from robot 601). In some non-limiting embodiments, the second end of docking arm 603 may be attached (e.g., by any fastening mechanism) to coupling mechanism 602.

In some non-limiting embodiments, coupling mechanism 602 may be configured to couple (e.g., attach) robot 601 to lawn mower 406 (e.g., a blade of lawn mower 406). In some non-limiting embodiments, coupling mechanism 602 may include at least one of a magnet, a clamp, a suction device, and/or any combination thereof. For example, coupling device 602 may be configured to attach magnetically to lawn mower 406, clamp onto lawn mower 106, and/or suction to a surface of lawn mower 406. In some non-limiting embodiments, docking system 102 may control coupling mechanism 602 to couple robot 601 to lawn mower 406. In some non-limiting embodiments, coupling mechanism 602 may include at least one second processor. The at least one second processor of coupling mechanism 602 may be configured to receive instructions from the at least one processor of docking system 102 instructing coupling mechanism 602 to couple robot 601 to lawn mower 406.

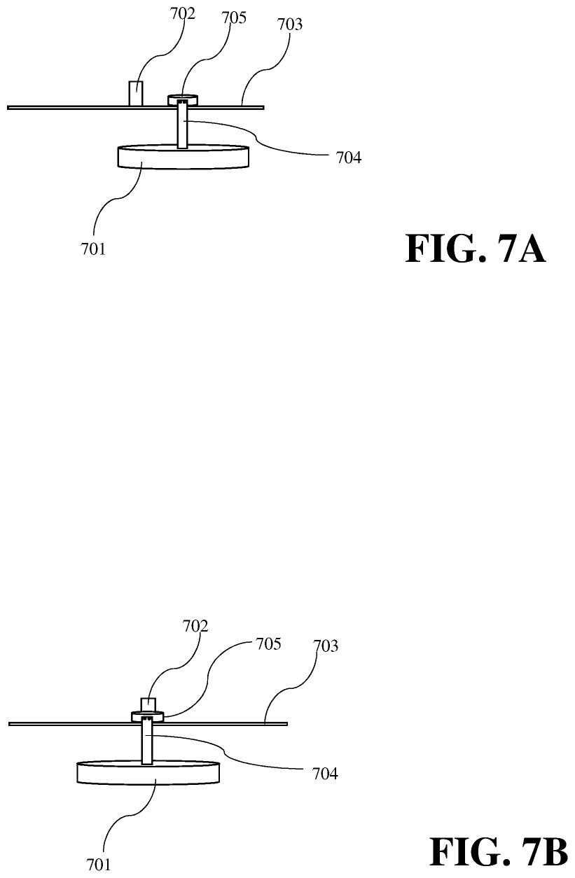

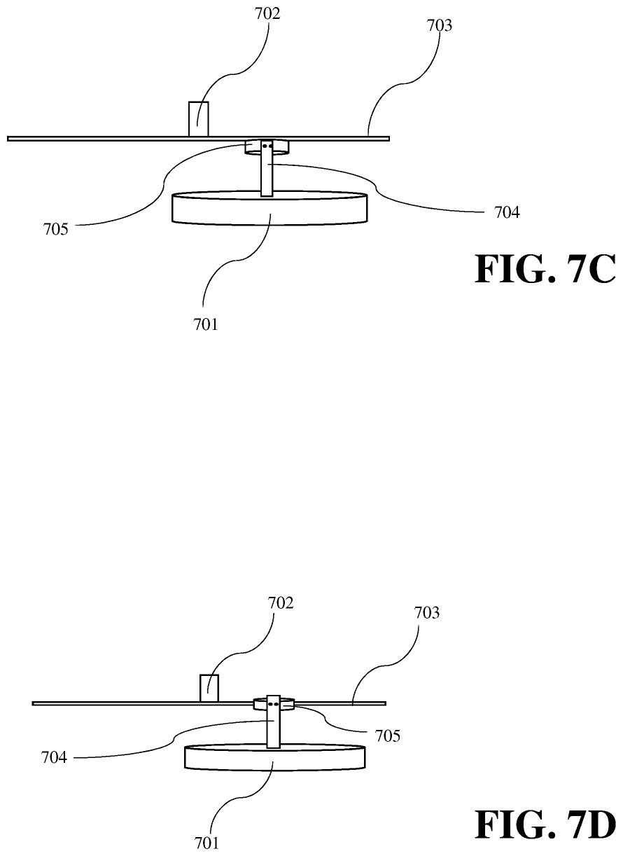

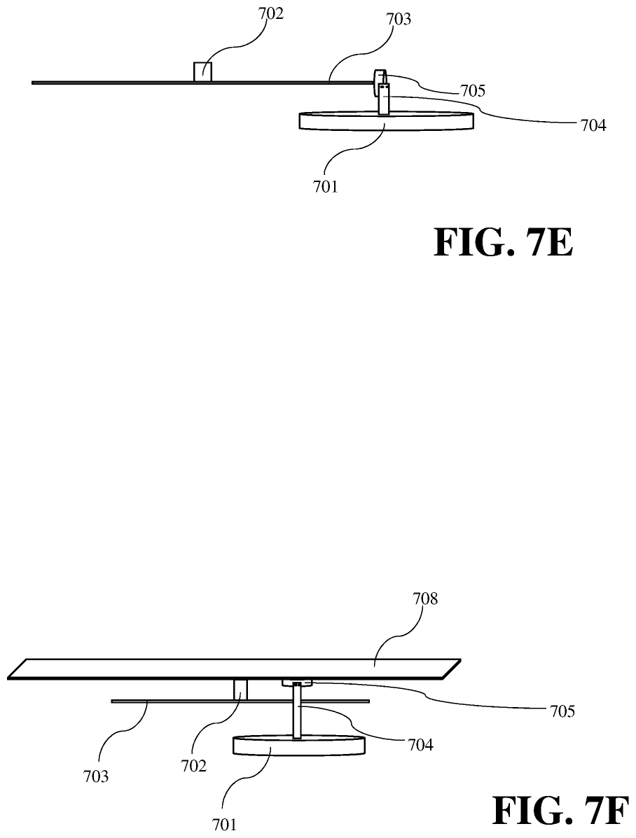

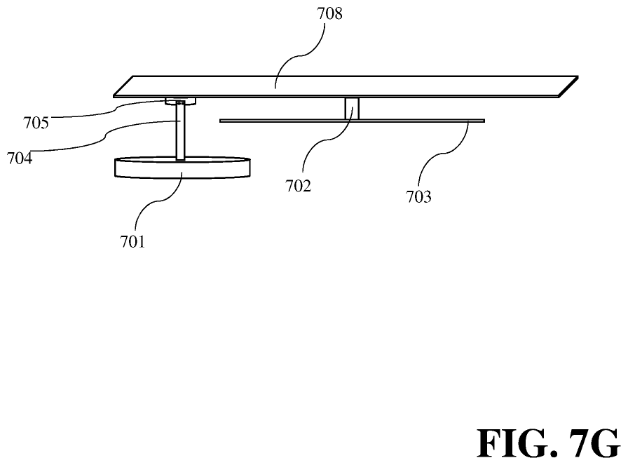

FIGS. 7A-7H are diagrams of example docking locations, according to some non-limiting embodiments. In some non-limiting embodiments, docking system 102 may dock robot 701 in one or more locations relative to lawn mower 106 (e.g., blade 703 and/or lawn mower deck 708). In some non-limiting embodiments, docking system 102 may include robot 701 and/or docking arm 704. In some non-limiting embodiments, robot 701 may be the same as, similar to, and/or part of robot 104, robot 304, and/or robot 601. In some non-limiting embodiments, docking arm 704 may be the same as, similar to, and/or part of docking arm 603.

In some non-limiting embodiments, lawn mower 106 may include blade 703 and/or lawn mower deck 708. Blade 703 may be the same as, similar to, and/or part of blade 11. Blade 703 may be attached (e.g., via blade spindle assembly 702) or detached from lawn mower 106. In some non-limiting embodiments, blade 703 may include 6 sides (e.g., a top side, a bottom side, a front side, a back side, a left side, and a right side). In some non-limiting embodiments, blade 703 may include blade spindle assembly 702. In some non-limiting embodiments, blade 703 may be attached to lawn mower 106 via blade spindle assembly 702. As shown in FIGS. 7D and 7F, blade 703 may be attached to lawn mower deck 708 (e.g., via blade spindle assembly 702).

In some non-limiting embodiments, docking system 102 may control docking arm 704 to dock at a location relative to lawn mower 406. For example, docking system 102 may control docking arm 704 to dock at docking location 705 relative to blade 703 and/or lawn mower deck 708.

As shown in FIGS. 7A-7E, robot 701 may be configured to dock at docking location 705, where docking location 705 is located on a side (e.g., a top side, a bottom side, a front side, a back side, a left side, and a right side) of blade 703. As shown in FIG. 7B, robot 701 may be configured to dock at docking location 705, where docking location 705 is at a location of blade spindle assembly 702.

In some non-limiting embodiments, lawn mower deck 708 may include six sides (e.g., a top side, a bottom side, a front side, a back side, a left side, and a right side). In some non-limiting embodiments, blade 703 and/or blade spindle assembly 702 may be located at the bottom side of lawn mower deck 708. As shown in FIGS. 7F and 7G, robot 701 may be configured to dock at docking location 705, where docking location 705 is at a location at the bottom side of lawn mower deck 708 and/or adjacent to blade 703 and/or blade spindle assembly 702.

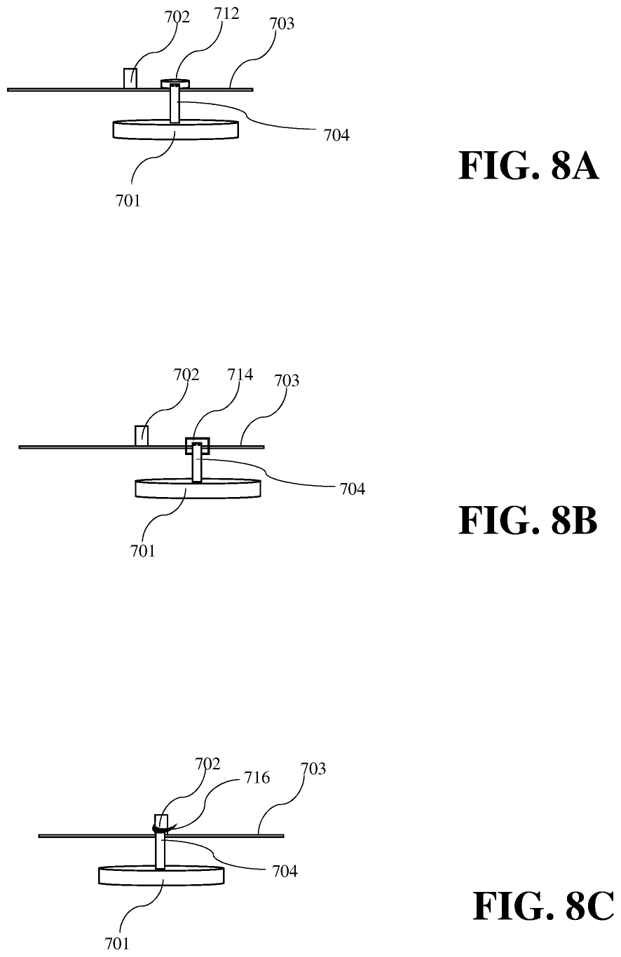

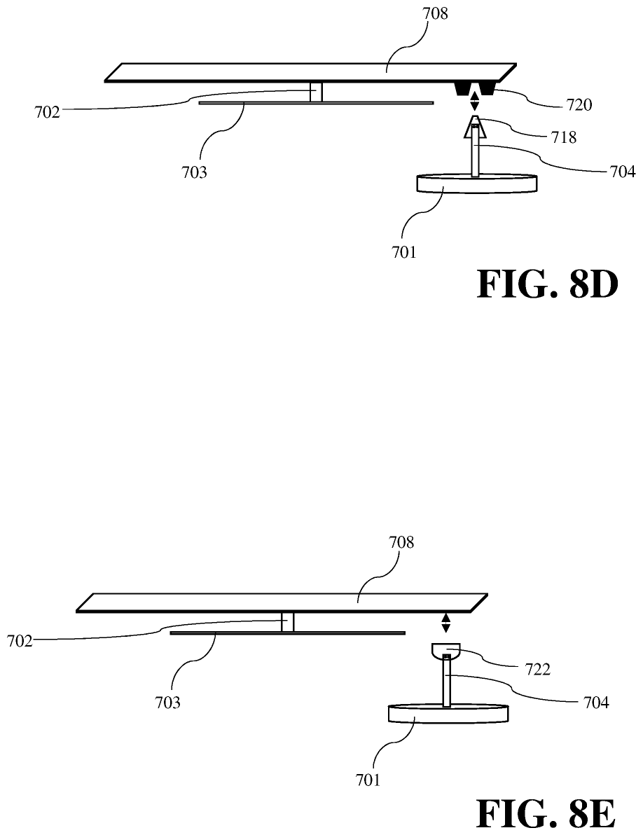

FIGS. 8A-8E diagrams of example coupling mechanisms, according to some non-liming embodiments. In some non-limiting embodiments, robot 701 may include coupling mechanisms 712, 714, 716, 718, 720, and/or 722.

In some non-limiting embodiments, coupling mechanisms 712, 714, 716, 718, 720, and/or 722 may be located at an end of docking arm 704. For example, coupling mechanisms coupling mechanisms (e.g., 712, 714, 716, 718, 720, and/or 722) may be located at an end of docking arm 704 away from robot 701. In some non-limiting embodiments, docking location 705 may be determined based on a location of coupling mechanisms coupling mechanisms (e.g., 712, 714, 716, 718, 720, and/or 722) relative to blade 703 and/or lawn mower deck 708.

In some non-limiting embodiments, coupling mechanisms (e.g., 712, 714, 716, 718, 720, and/or 722) may be operatively connected to the at least one processor of docking system 102. For example, docking system 102 may control coupling mechanisms (e.g., 712, 714, 716, 718, 720, and/or 722) to couple to (e.g., attach to) and/or de-couple from (e.g., release from) blade 703 and/or lawn mower deck 708. In some non-limiting embodiments, at least one of coupling mechanisms 712, 714, 716, 718, 720, and/or 722 may include at least one second processor, the at least one second processor of the at least one coupling mechanism configured to receive instructions from the at least one processor of docking system 102 to couple to and/or de-couple from blade 703 and/or lawn mower deck 708.

As shown in FIG. 8A, the coupling mechanism may include magnet 712. For example, magnet 712 may be configured to couple robot 701 (e.g., docking arm 704) to blade 703 and/or lawn mower deck 708 at docking location 705 using one or more magnets. In some non-limiting embodiments, blade 703 and/or lawn mower deck 708 may include one or more magnets. For example, at least one side of blade 703 and/or lawn mower deck 708 may include one or more magnets configured to couple with magnet 712.

As shown in FIGS. 8B and 8C, the coupling mechanism may include claw 714 and/or clamp 716. Claw 714 and/or clamp 716 may be configured to couple robot 701 (e.g., docking arm 704) to blade 703 and/or lawn mower deck 708. Claw 714 and/or clamp 716 may include a locking mechanism configured to secure the coupling of robot 701 to blade 703 and/or lawn mower deck 708.

As shown in FIG. 8D, the coupling mechanism may include a pairing device comprising insertion portion 718 and receiving portion 720. In some non-limiting embodiments, receiving portion 720 may be configured to receive insertion portion 718. In some non-limiting embodiment, insertion portion 718 may include an edge and/or wings configured expand to an expanded position and/or contract to a contracted position to secure insertion portion 718 into place upon being received by receiving portion 720. In some non-limiting embodiments, insertion portion 718 may be attached to an end of docking arm 704, to a side of blade 703, and/or to a side of lawn mower deck 708. In some non-limiting embodiments, receiving portion 720 may be attached to an end of docking arm 704, to a side of blade 703, and/or to a side of lawn mower deck 708. Insertion portion 718 and/or receiving portion 720 may be configured to couple robot 701 (e.g., docking arm 704) to blade 703 and/or lawn mower deck 708.

As shown in FIG. 8E, the coupling mechanism may include suction device 722. Suction device 722 may be configured to couple robot 701 (e.g., docking arm 704) to blade 703 and/or lawn mower deck 708. Suction device 722 may include a vacuum, a pressurized device, or any other type of suction device configured to create a seal between robot 701 (e.g., docking arm 704) and blade 703 and/or lawn mower deck 708.

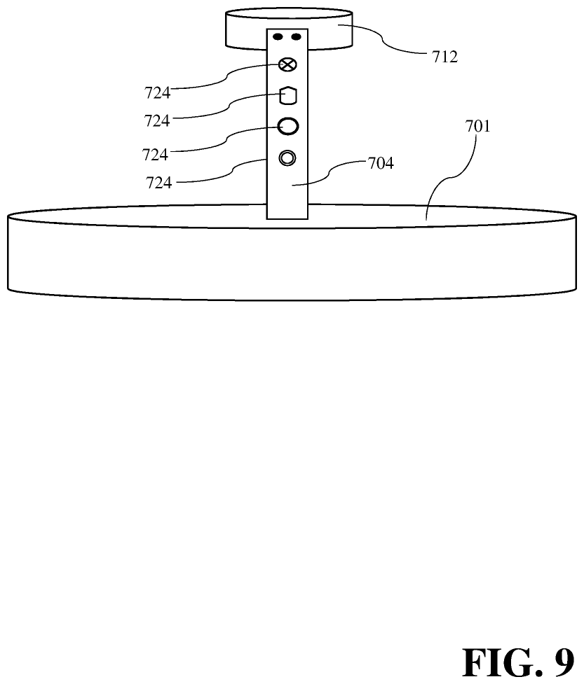

FIG. 9 is a diagram of robot 701 including docking arm 704 and coupling mechanism 712, according to some non-limiting embodiments. In some non-limiting embodiments, docking arm 704 may include one or more components 724. For example, docking arm 704 may include one or more sensors, buttons, speakers, illumination devices, indicators, cameras, lasers, and/or displays. The one or more sensors may include light detection and ranging (LiDAR) sensor(s), ToF sensor(s), proximity sensor(s), optical sensor(s), image sensor(s), or any combination thereof. In some non-limiting embodiments, the one or more components of docking arm 604 may be operatively connected to the at least one processor of docking system 102. For example, docking system 102 may control one or more components of docking arm 604. In some non-limiting embodiments, the one or more components of docking system 102 may include at least one second processor configured to communicate with the at least one processor of docking system 102.

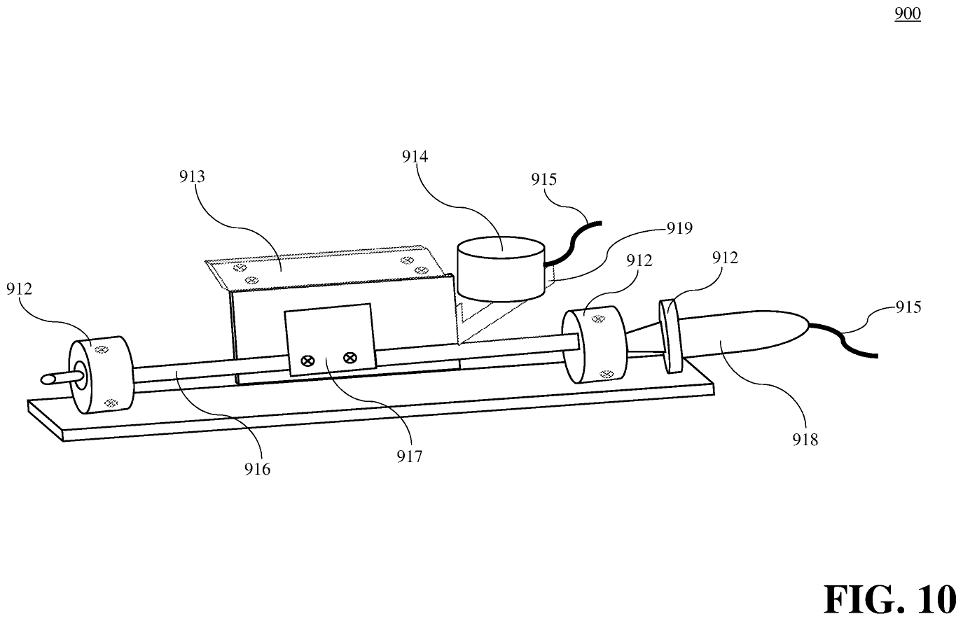

FIG. 10 is a diagram of a docking system unit 900, according to some non-limiting embodiments. In some non-limiting embodiments, docking system unit 900 may include brackets 912 configured to hold and/or guide a sharpening mechanism, brackets 913 configured to mount docking system unit 900; coupling mechanism 914, power cord 915, guide 916 configured to guide the sharpening mechanism, bracket 917 configured to hold the sharpening mechanism, motor 918 configured to drive the sharpening mechanism holder, bracket 919 configured to hold/support one or more of the coupling mechanisms.

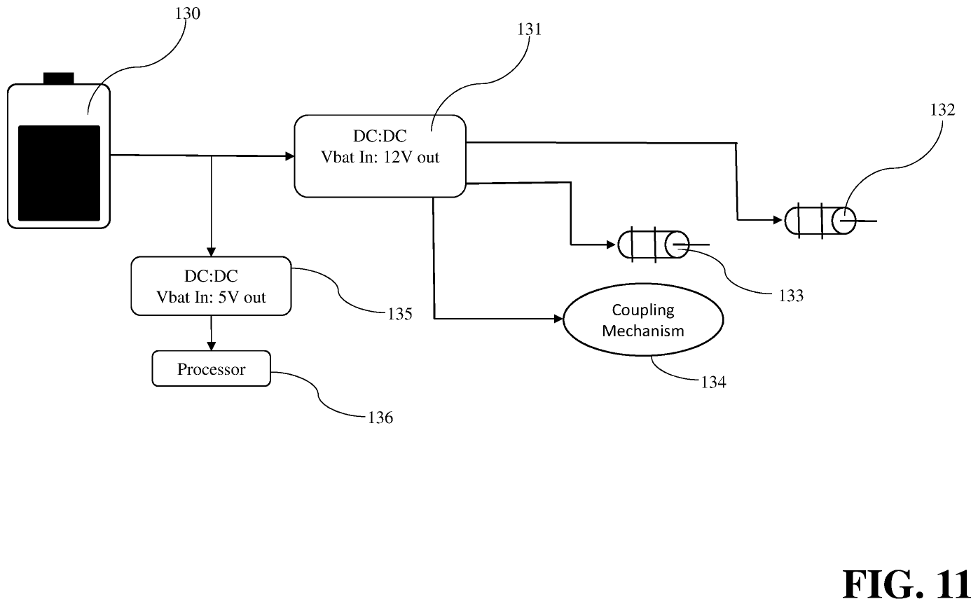

FIG. 11 is a schematic diagram of the docking system unit 900, according to some non-limiting embodiments. Docking system unit 900 may include an external and/or internal power source 130; one or more voltage sources 131, 135, one or more motors 132, 133, coupling mechanism 134, and at least one processor 136.

In some non-limiting embodiments, at least one voltage source 131, 135 may be configured to supply voltage to one or more motors 132, 133, coupling mechanism 134, and/or processor 136. Processor 136 may be the same as, similar to, and/or part of the at least one processor of docking system 102.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A docking system for docking a robot relative to a lawn mower, comprising:
a drive system configured to move the robot;
a sensor;
a docking arm; and
at least one processor operatively connected to the drive system, the sensor, and the docking arm, the at least one processor configured to:
receive a signal from the sensor, the signal comprising data from a first location of the robot;
control the drive system to drive from the first location to a second location based on receiving the signal from the sensor;
control the docking arm to dock the at the second location, wherein the robot is configured to perform a task associated with the lawn mower at the second location; and
control the docking arm to un-dock the robot from the second location upon completion of the task associated with the lawn mower.

2. The docking system of claim 1, wherein the docking arm comprises a first end connected to the robot and a second end, wherein the second end is connected to a coupling mechanism, wherein the coupling mechanism is operatively connected to the at least one processor, and wherein the at least one processor is further configured to:
control the coupling mechanism to couple the robot to the lawn mower, wherein the coupling mechanism comprises a magnet, and wherein the coupling mechanism is configured to magnetically attach the robot to the lawn mower.

3. The docking system of claim 1, wherein the docking arm comprises a first end connected to the robot and a second end, wherein the second end is connected to a coupling mechanism, wherein the coupling mechanism is operatively connected to the at least one processor, and wherein the at least one processor is further configured to:
control the coupling mechanism to couple the robot to the lawn mower, wherein the coupling mechanism comprises a clamp, and wherein the coupling mechanism is configured to clamp the robot to the lawn mower.

4. The docking system of claim 1, wherein the docking arm comprises a first end connected to the robot and a second end, wherein the second end is connected to a coupling mechanism, wherein the coupling mechanism is operatively connected to the at least one processor, and wherein the at least one processor is further configured to:
control the coupling mechanism to couple the robot to the lawn mower, wherein the coupling mechanism comprises a suction device, and wherein the coupling mechanism is configured to suction the robot to the lawn mower.

5. The docking system of claim 1, wherein the at least one processor is further configured to:
control the drive system to drive from the second location to a third location in response to controlling the docking arm to un-dock the robot from the second location.

6. The docking system of claim 1, wherein, when controlling the docking arm to dock the robot at the second location, the at least one processor is configured to:
determine a location of a blade of the lawn mower; and
control the docking arm to dock the robot to lawn mower at the location of the blade of the lawn mower.

7. The docking system of claim 1, further comprising a task arm, wherein the task arm is operatively connected to the at least one processor, wherein the at least one processor is further configured to:
control the task arm to complete the task associated with the lawn mower, wherein the task comprises sharpening a blade of the lawn mower.

8. The docking system of claim 1, wherein the at least one processor is configured to control the docking arm to move in an upward direction, a downward direction, and/or rotate.

9. The docking system of claim 1, wherein the docking arm is static.

10. The docking system of claim 1, wherein the drive system comprises at least one second processor, and wherein the at least one second processor is configured to:
receive data from the at least one processor, the data comprising instructions to drive from the first location to the second location; and
drive the robot from the first location to the second location in response to receiving the instructions.

11. A method for docking a robot relative to a lawn mower,
the robot comprising:
a drive system configured to move the robot;
a sensor;
a docking arm; and
at least one processor operatively connected to the drive system, the sensor, and the docking arm;
the method comprising:
receiving, by the at least one processor, a signal from the sensor, the signal comprising data from a first location of the robot;
controlling, by the at least one processor, the drive system to drive from the first location to a second location based on receiving the signal from the sensor;
controlling, by the at least one processor, the docking arm to dock the robot at the second location, wherein the robot is configured to perform a task associated with the lawn mower at the second location; and
controlling, by the at least one processor, the docking arm to un-dock the robot upon completion of the task associated with the lawn mower.

12. The method of claim 11, wherein the docking arm comprises a first end connected to the robot and a second end, wherein the second end is connected to a coupling mechanism, wherein the coupling mechanism is operatively connected to the at least one processor, the method further comprising:
controlling the coupling mechanism to couple the robot to the lawn mower, wherein the coupling mechanism comprises a magnet, and wherein the coupling mechanism is configured to magnetically attach the robot to the lawn mower.

13. The method of claim 11, wherein the docking arm comprises a first end connected to the robot and a second end, wherein the second end is connected to a coupling mechanism, wherein the coupling mechanism is operatively connected to the at least one processor, the method further comprising:
controlling the coupling mechanism to couple the robot to the lawn mower, wherein the coupling mechanism comprises a clamp, and wherein the coupling mechanism is configured to clamp the robot to the lawn mower.

14. The method of claim 11, wherein the docking arm comprises a first end connected to the robot and a second end, wherein the second end is connected to a coupling mechanism, wherein the coupling mechanism is operatively connected to the at least one processor, the method further comprising:
controlling the coupling mechanism to couple the robot to the lawn mower, wherein the coupling mechanism comprises a suction device, and wherein the coupling mechanism is configured to suction the robot to the lawn mower.

15. The method of claim 11, further comprising:
controlling, by the at least one processor, the drive system to drive from the second location to a third location in response to controlling the docking arm to un-dock the robot from the second location.

16. The method of claim 11, wherein, controlling the docking arm to dock the robot at the second location further comprises:
determining a location of a blade of the lawn mower; and
controlling the docking arm to dock the robot to lawn mower at the location of the blade of the lawn mower.

17. The method of claim 11, wherein the robot further comprises a task arm, wherein the task arm is operatively connected to the at least one processor, and wherein the method further comprises:
controlling, by the at least one processor, the task arm to complete the task associated with the lawn mower, wherein the task comprises sharpening a blade of the lawn mower.

18. The method of claim 11, further comprising:
controlling the docking arm to move in an upward direction, a downward direction, and/or rotate.

19. The method of claim 11, wherein the docking arm is static.

20. The method of claim 11, wherein the drive system comprises at least one second processor, the method further comprising:
receiving, by at least one second processor of the drive system data from the at least one processor, the data comprising instructions to drive from the first location to the second location; and
driving, by at least one second processor of the drive system, the robot from the first location to the second location in response to receiving the instructions.
